(19) United States
(12) Patent Application Publication
(10) Pub. No.: US 2009/0132439 A1
(43) Pub. Date: May 21, 2009

(54) Method of storing and distributing regulated goods

(76) Inventors: Todd D. Graham, Houston, TX (US); Michael J. Anders, Houston, TX (US)

Correspondence Address: TED M. ANTHONY;BABINEAUX, POCHE, ANTHONY & SLAVICH, L.L.C, P.O. DRAWER 52169, LAFAYETTE, LA, 70505-2169, US

(21) Appl. No.: 12/321,575

(22) Filed: Jan. 22, 2009

Related U.S. Application Data
(63) Continuation-in-part of application No. 11/166,295, filed on Jun. 24, 2005, now abandoned.

(51) Int. Cl. G06Q 90/00

(52) U.S. Cl. 705/500

(57) ABSTRACT

A segregated area for the storage of regulated goods is subleased or otherwise acquired from the operator of a warehouse that is used to store unregulated goods. The segregated area can be manned with support personnel, and appropriately isolated or otherwise separated from the remainder of the host warehouse in accordance with applicable regulations. Upon receipt of an order for such regulated goods, custody and control of the regulated goods is transferred directly to the host warehouse operator at the warehouse facility and the regulated goods are transported, ideally along with unregulated goods, to a third party purchaser.

### CROSS REFERENCES TO RELATED APPLICATIONS

THIS IS A CONTINUATION-IN-PART OF application Ser. No. 11/166,295, FILED Jun. 24, 2005, CURRENTLY PENDING.

### STATEMENTS AS TO RIGHTS TO INVENTIONS MADE UNDER FEDERALLY SPONSORED RESEARCH AND DEVELOPMENT

NONE

### BACKGROUND OF THE INVENTION

1. Field of the Invention

The present invention pertains to a method of storing and distributing regulated goods that are subject to governmental regulation including, but not necessarily limited to, alcoholic beverages. More particularly, the present invention pertains to a method of improving efficiency and reducing redundancy in the storage and distribution of regulated goods.

2. Description of the Prior Art

In many jurisdictions, the storage, distribution and/or sale of certain goods are subject to significant governmental regulation. By way of example, but not limitation, alcoholic beverages such as beer, wine, liquor and the like, are often heavily regulated by states and their political subdivisions. As a result, such regulated goods must be distributed and sold in accordance with detailed regulations promulgated by legislative bodies and/or applicable regulatory agencies.

Frequently, such regulation imposes additional requirements that would not otherwise exist. These additional requirements can often increase the costs associated with a particular activity.

For example, in certain locations, alcoholic beverages must be distributed in accordance with specific rules established by applicable regulatory agencies. Often, such regulations mandate that alcoholic beverages must be segregated from other types of food and/or beverages. As such, distributors of alcoholic beverages must typically maintain their inventory of alcoholic beverages in separate facilities which are used exclusively to house such goods. Further, in many instances, a “three-tiered” ownership structure must be maintained; that is, separate and distinct ownership as between the manufacturer(s), distributor(s) and retailers(s) of such alcoholic beverages. When a purchase order is received, such as from a grocery store or other retail outlet, alcoholic beverage distributors typically retrieve the ordered goods from a dedicated storage facility and arrange for the independent transportation of such alcoholic beverage(s) from the storage facility to the store or other location.

This common scenario is both inefficient and wasteful. First, use of dedicated storage facilities can be extremely expensive. Such facilities must be relatively large, and must be constructed, leased or purchased. Generally, such dedicated storage facilities often have significant energy consumption characteristics. Second, the regulated goods must be transported, via dedicated carrier(s), from such storage facility to their ultimate destination (e.g., store, retail outlet, etc.).

Thus, it is an object of the present invention to provide a novel method of storing and distributing regulated goods which eliminates many of the inefficiencies associated with current methods of handling regulated goods.

### SUMMARY OF THE INVENTION

The present invention comprises a method of storing and distributing regulated goods including, but not necessarily limited to, alcoholic beverages and the like. The method of the present invention improves the efficiency of current methods of storing and distributing such regulated goods.

The present invention comprises the establishment of at least one isolated area for the storage of regulated goods within, or at least in general proximity to, a warehouse or storage facility used for storing unregulated goods. For example, in the case of alcoholic beverages, applicable governmental regulations require that alcoholic beverages be maintained separate and apart from other unregulated goods. Thus, pursuant to the method of the present invention, alcoholic beverages are stored within specified, isolated portions of warehouses and/or other facilities used to store groceries and/or other unregulated goods. In the preferred embodiment of the present invention, such alcoholic beverages are stored together in segregated area(s) of larger general use warehouses, such as wholesale grocery warehouses.

In the preferred embodiment of the present invention, a segregated area is purchased, leased, subleased or otherwise acquired from the operator of a warehouse that is used to store unregulated goods. If necessary, such area can be manned with a dedicated support staff, and appropriately isolated or otherwise separated from the rest of such main warehouse, so as to adequately separate regulated goods from non-regulated goods in accordance with applicable regulations. Significantly, the regulated goods are not stored with, and do not come in direct contact with, unregulated goods.

When a third party contracts for the purchase of such regulated goods, custody and control of the regulated goods can be transferred directly to the warehouse operator at the warehouse facility. The regulated goods can thereafter be transported, ideally along with unregulated goods, to such purchaser.

### BRIEF DESCRIPTION OF THE DRAWINGS

FIG. 1 is a flow chart illustrating a method for storing and distributing regulated goods according to the present invention.

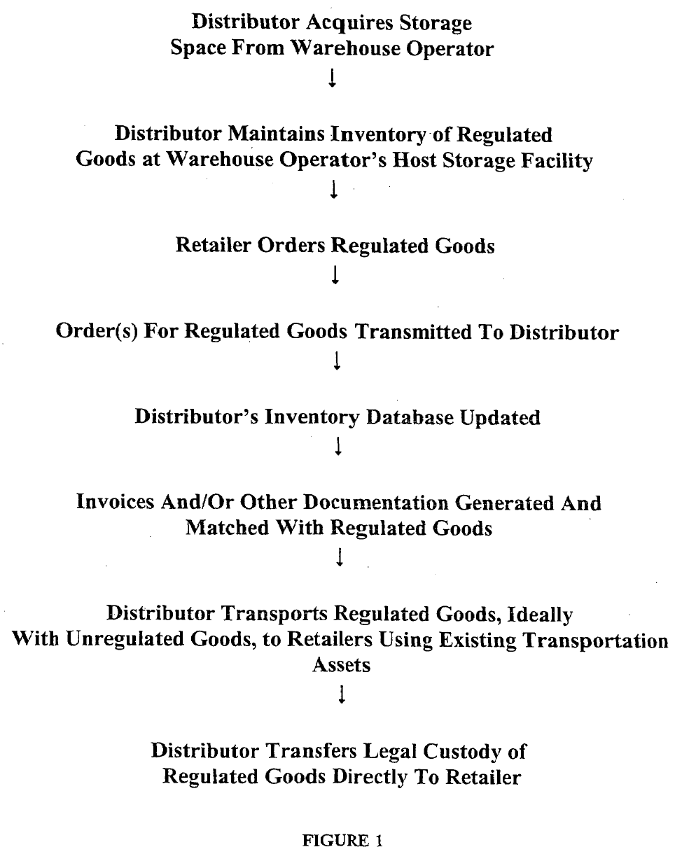

### DETAILED DESCRIPTION OF THE PRESENT INVENTION

The present invention comprises the establishment of at least one isolated area for the storage of regulated goods within, or at least in general proximity to, a warehouse or storage facility used for the storage of unregulated goods. For purposes of this disclosure, alcoholic beverages, which are heavily regulated by various governmental agencies, are used to illustrate the method of the present invention. However, it is to be observed that the method of the present invention can also be utilized in connection with various other types of regulated goods. Accordingly, the scope of the present invention should not be construed as being limited only to alcoholic beverages.

Applicable governmental regulations require that alcoholic beverages be maintained separate and apart from other unregulated goods. As such, distributors of such alcoholic beverages are generally required to maintain separate, dedicated warehouses for the storage of alcoholic beverages.

In the preferred embodiment of the present invention, a distributor of regulated goods, such as alcoholic beverages, will purchase, lease, sublease or otherwise acquire space from the operator of a warehouse that is used to store unregulated goods. Such unregulated goods may include, for example, groceries or other foodstuffs; however, it is to be observed that the unregulated goods stored in the host warehouse may or may not bear some similarity to the regulated goods.

If necessary, such subleased (or otherwise acquired) area can be manned with dedicated support personnel, and appropriately isolated or otherwise separated from the rest of such main warehouse so as to adequately segregate regulated goods from non-regulated goods in accordance with applicable regulations. For example, in the case of alcoholic beverages, the regulated goods are not stored directly with unregulated goods, such as groceries or other basic foodstuffs.

When a third party contracts with the distributor for the purchase of regulated goods, custody and control of such goods are transferred directly to the warehouse operator at the host warehouse facility. In other words, the goods are transferred from subleased (or otherwise acquired), segregated portion of the warehouse to other portions of the warehouse. However, ownership of such regulated goods are not transferred. The regulated goods can thereafter be transported, ideally along with unregulated goods, to a third party purchaser.

Although not absolutely required, it is often beneficial for the distributor and warehouse operator to have some form of common relationship with the third party purchaser(s). For instance, using the alcoholic beverage example, an alcoholic beverage distributor can sublease warehouse space from a grocery wholesaler having a warehouse. When an order is received from a grocery store or other retail outlet, alcoholic beverages can be transferred from the segregated subleased (or otherwise acquired) portion of the warehouse to the “main” portion of the warehouse. Thereafter, the alcoholic beverages can be transported along with other groceries from the wholesale warehouse to the third party purchaser's grocery store or retail outlet. Under this scenario, both regulated and unregulated goods are transported in a single shipment, thereby reducing the number of required delivery runs.

In the preferred embodiment of the present invention wherein the regulated goods are alcoholic beverages, a multi-tiered ownership structure can be strictly maintained. Namely, separate and distinct ownership can exist as between the manufacturer(s), distributor(s) and retailers(s) of such alcoholic beverages. As such, when alcoholic beverages are maintained in a segregated section of a warehouse or other similar facility, ownership of such alcoholic beverages remains with distributor and is never transferred to the grocery wholesaler or other owner of unregulated goods. Ownership of the alcoholic beverages remains with the distributor at all times until the alcoholic beverages are sold to the retailer, when ownership of such alcoholic beverages transfers. Thus, there is never common ownership of the alcoholic beverages and unregulated goods by the same party at the same time.

The above-described invention has a number of particular features which should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention

What is claimed:

1. A method of distributing alcoholic beverages comprising the steps of:
a. establishing a segregated area within a storage facility containing unregulated goods;
b. maintaining a stock of alcoholic beverages within said segregated area, wherein ownership of said alcoholic beverages is different from ownership of such unregulated goods;
c. selecting certain alcoholic beverages from said segregated area; and
d. delivering said selected alcoholic beverages to a purchaser.

2. The method of claim 1, wherein said selected alcoholic beverages are delivered with unregulated goods using a common means of transportation.

3. The method of claim 2, wherein said common means of transportation is a truck.
